(19) United States
(12) Patent Application Publication
(10) Pub. No.: US 2008/0228388 A1
(43) Pub. Date: Sep. 18, 2008

(54) Map display apparatus for vehicle

(75) Inventors: Nobutaka Tauchi, Toyoake-city (JP); Keisuke Uto, Tokyo (JP)

Correspondence Address: POSZ LAW GROUP, PLC, 12040 SOUTH LAKES DRIVE, SUITE 101, RESTON, VA, 20191, US

(73) Assignee: DENSO CORPORATION, Kariya-city (JP)

(21) Appl. No.: 12/068,262

(22) Filed: Feb. 5, 2008

(30) Foreign Application Priority Data
Feb. 12, 2007 (JP) 2007-31416

(51) Int. Cl. G01C 21/36

(52) U.S. Cl. 701/201

(57) ABSTRACT

A transit time period from a departure point is inputted. A first road map is once displayed to have a broad covering range to include the departure point and an estimated reachable point, which the vehicle reaches after the transit time period elapses. Then, a second road map having a covering range narrower than that of the first road map is displayed to include only the estimated reachable point without including the departure point. This allows the user to easily recognize the positional relationship between the estimated reachable point and the departure point, and an approximate position of the estimated reachable point against the guide route.

### CROSS REFERENCE TO RELATED APPLICATION

This application is based on and incorporates herein by reference Japanese Patent Application No. 2007-31416 filed on Feb. 12, 2007.

### FIELD OF THE INVENTION

The present invention relates to a vehicular map display apparatus and, in particular, to a vehicular map display apparatus intelligibly providing a driver with a map in proximity of a reachable point on a designated guide route.

### BACKGROUND OF THE INVENTION

A map display apparatus in Patent document 1 can check a position, at which the apparatus is estimated to be located in the past and in the future. For instance, when a past clock time preceding the present clock time is designated, a map is displayed in the display device based on positional information recorded in a memory. In contrast, when a future clock time following the present clock time is designated, a map is displayed in the display device to indicate a position to which the present position is moved along the guide route by an estimated travel distance, which is obtained from an average vehicle speed.

The designated clock time can be changed to the past or future every predetermined unit of time (e.g., 10 minutes) by operating a backward button or forward button. The map is displayed when the operation to the button is completed; further, the map is scrolled while the clock time is being changed during the operation to the button.

Patent document 1: JP-H11-202759A

In the conventional map display apparatus, a future clock time may be designated to have a great time difference from the present clock time. Thus, the map presently displayed may be switched to a map covering a remote point far from the present point. In such a case, the user may feel it difficult to understand which part of the guide route the remote point is located at (i.e., a position of the remote point on the guide route), a distance or direction to the remote point from the present point, etc.

Such a problem may arise similarly even when the map is scrolled to meet the change of the set clock time up to the end of setting. In the conventional map display apparatus, when the displayed map can be scrolled to display the significantly remote area, intermediate area or points can be displayed during the scrolling. However, since the scrolling is continued, the intermediate area can appear only for a while and disappear shortly. Further, the covering range of the displayed road map during the scrolling is the same as that of the road map originally indicating the present point. Thus, it is still difficult to understand the positional relationship between the present point and the remote point, such as a distance or direction from the present point to the remote point or which position on the guide route the remote point is located at.

### SUMMARY OF THE INVENTION

The present invention is made in view of the problem above. It is an object to provide a vehicular map display apparatus to display a road map to allow a user to easily recognize a relationship of a point on a guide route reachable after a transit time period from a departure point.

To achieve the above object, according to an example of the present invention, a map display apparatus for a vehicle is provided as follows. A road map data storage device is configured to store road map data. A display device is configured to display a road map using the road map data. A guide route designation unit is configured to designate a guide route from a departure point to a destination based on the road map data. An input device is configured to input a transit time period based on an operation of a user. A reachable point calculation unit is configured to calculate a reachable point on the guide route, the reachable point which the vehicle is estimated to reach when the transit time period elapses after the vehicle starts from the departure point. A display control unit is configured to cause the display device to display a road map with a first reduction scale having a covering range including the departure point and the reachable point and then to display a road map with a second reduction scale having a covering range including the reachable point, the covering range of the second reduction scale being narrower than the covering range of the first reduction scale.

### BRIEF DESCRIPTION OF THE DRAWINGS

The above and other objects, features, and advantages of the present invention will become more apparent from the following detailed description made with reference to the accompanying drawings. In the drawings:

FIG. 1 is a block diagram illustrating a configuration of a navigation apparatus serving as a vehicular map display apparatus according to an embodiment of the present invention;

FIG. 2 is a perspective view illustrating an example of an operation device;

FIG. 3 is a block diagram illustrating a configuration of a controller for controlling a haptic device serving as an operation device;

FIGS. 4A to 4C are drawings illustrating examples of displaying road maps in a time scroll process;

FIG. 4D is a diagram explaining a procedure to display peripheral road maps of individual points on a guide route in a time scroll process;

FIG. 5 is an example of an operation window in a time scroll process; and

FIG. 6 is an example of a road map displaying multiple points reachable from a destination; and

FIG. 7 is a flowchart illustrating a time scroll process.

### DETAILED DESCRIPTION OF THE PREFERRED EMBODIMENTS

A navigation apparatus serving as a map display apparatus according to an embodiment of the present invention will be explained with reference to drawings.

The navigation apparatus 20 mounted in a subject vehicle detects a position of the subject vehicle and displays it with the peripheral map. The navigation apparatus 20 has further a navigation function to retrieve a guide route to a destination to thereby provide route guidance to follow the guide route. The navigation apparatus 20 has yet further a communication function to acquire positional information or traffic information from an outside.

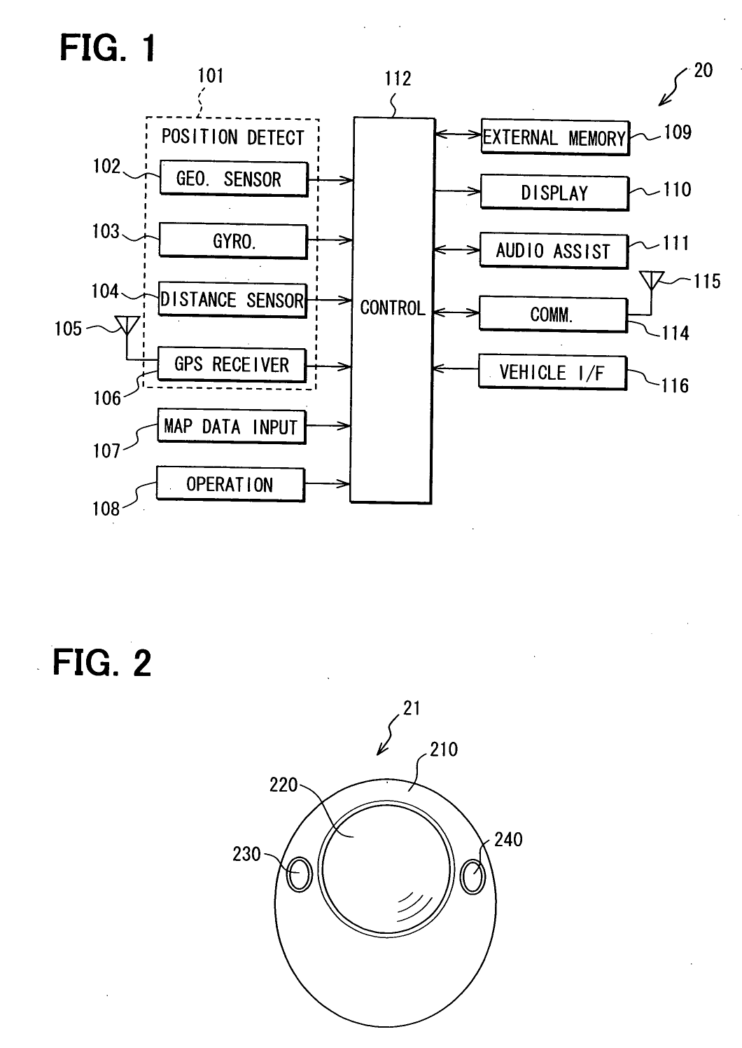

As illustrated in FIG. 1, the navigation apparatus 20 includes the following: a position detector 101 to detect a present position of the vehicle; a map data input device 107 equipped with a storage medium which records map data and various kinds of information; an operation device 108 to input various demands or instructions from a user; an external memory 109 to store various kinds of data; a display device 110 to display various kinds of display windows such as a map display window and a TV window on the display screen thereof; an audio assist/speech recognition device 111 to output various kinds of guide sounds or recognize user's speeches; a communication device 114 to perform a short distance wireless communication such as Blue Tooth; and a vehicle l/F device 116 to communicate vehicular information. The navigation apparatus 20 further includes a control circuit 112 to perform various processing according to inputs from the position detector 101, the map data input device 107, the operation device 108, the external memory 109, the communication device 114, the vehicle I/F device 116, etc. and to control the external memory 109, the display device 110, the audio assist/speech recognition device 111, and the communication device 114.

The position detector 101 includes the following sensors or the like: a geomagnetic sensor 102 to detect a heading direction of the vehicle using earth magnetism; a gyroscope 103 to detect rotational movement applied to the vehicle; a distance sensor 104 to detect a travel distance from a forward or backward acceleration of the vehicle; and a GPS receiver 106 to detect a position, heading direction, and speed of the vehicle by receiving transmit electric waves from GPS satellites via a GPS antenna 105. The above sensors or the like 102 to 106 have different types of detection errors, so they are used to complement each other. In addition, depending on the required detection accuracy, only part of the above sensors may be used or another sensor such as a rotation sensor of the steering wheel, a wheel sensor of each following wheel, etc may be used to detect a heading direction or travel distance of the vehicle.

The map data input device 107 is used for inputting various data into the control circuit 112. The data include road map data for displaying road maps, map data such as map matching data for improving accuracy of position of the vehicle, facility data having various kinds of information about facilities on the map data (kinds, positions, names, addresses, etc.), facility mark data for displaying various facilities, and other data containing images, audio, etc. for the guidance. A storage medium of these data includes a CD-ROM, DVD-ROM, hard disk, memory, memory card, or the like. Thus, the map data input device 107 can function as a road map data storage device configured to store road map data.

The road map data include multiple road map data for individual reduction scales such as 1/5000, 1/10,000, 1/20,000, 1/40,000, 1/80,000, etc., to thereby allow road map display with multiple steps of reduction scales. For example, when the user specifies a reduction scale, the road map of the specified reduction scale can be displayed.

Furthermore, in the present embodiment, a guide route is designated and a reachable point on the guide route is then specified using a transit time period from a departure point. A time scroll process is then performed which changes or moves the map display window so as to show a map in proximity of the specified reachable point on the guide route. In the time scroll process, the reduction scales used for displaying road maps seem to be continuously changed to each other by using the road maps with the multiple steps of reduction scales. For instance, there is a case where the reduction scale of the road map is changed from 1/5000 to 1/10,000. In such a case, part of the road map with the reduction scale of 1/10,000 is expanded with a varied magnification coefficient to thereby show the road map with reduction scales between 1/5000 and 1/10,000. The magnification coefficient can be varied with multiple steps as needed. Thus, the road map can be displayed such that the reduction scale of the road map seems to change continuously. The time scroll process will be explained in detail later.

For instance, the external memory 9 is a hard disk storage device, and stores a destination designated by an operation of the user or various kinds of data of the guide route to the destination, etc.

The display device 110 includes any one of a liquid crystal display, a plasma display, a CRT, etc. The display screen of the display device 110 displays a vehicle mark indicating a present position of the vehicle and its peripheral map based on the present position detected by the position detector 101 and road map data inputted from the map data input device 107. On the peripheral map, additional data such as a guide route to a destination, a name, a landmark, and a facility mark can be displayed in superimposition. Moreover, guidance of facilities can be also displayed in the display device 110.

The audio assist/speech recognition device 111 can output sounds of the guidance of facilities and various guidance inputted from the map data input device 107, and read-aloud sounds of information acquired through the vehicle I/F device 116.

The communication device 114 is for performing dedicated short range communications, for example, DSRC, Blue Tooth (registered trademark), wireless LAN, UWB(Ultra Wide Band), etc. The communication device 114 is used to communicate with a cellular phone carried into the vehicle, or with a navigation apparatus mounted in another vehicle.

The vehicle I/F device 116 is used for outputting and inputting various kinds of external information. For instance, the vehicle I/F device 116 inputs vehicle state detection signals, FM broadcasting signals received via a radio aerial (not illustrated), and radio wave beacon signals and optical beacon signals received from fixed stations for VICS (vehicle information and communication system) services arranged near roads.

The control circuit 112 includes a known microcomputer having a CPU, ROM, RAM, I/O, and a bus line connected with the foregoing. Various controls are executed in order to exhibit the navigation function and communication function based on programs stored in the ROM or the like. In addition, the control circuit 112 executes a time scroll process mentioned later as one of the navigation function. In addition, the control circuit 112 executes a route retrieval process and a route guide process. In the route retrieval process, a facility or point serving as a destination is selected according to an operation of the operation device 108, and an optimal guide route is retrieved from the present position to the destination. In the route guide process, a travel guide for the vehicle is performed according to the retrieved guide route. Thus, the control circuit 112 can function as a guide route designation means or unit configured to designate a guide route from a departure point to a destination based on the road map data.

FIG. 2 is a perspective view illustrating an example of the operation device 108. In the present embodiment, a haptic device (tactile sense notification device) 21 illustrated in FIG. 2 is used as the operation device 108. The haptic device 21 is attached to a center console portion of the vehicle, for example.

The haptic device 21 includes a trackball holding unit 210, a trackball unit 220, a determination switch 230, and a return switch 240. The user rotates the trackball unit 220 to thereby move a pointer to an intended position on the display screen. When the intended position includes a display switch, execution of an operation corresponding to the display switch can be directed by pressing the determination switch 230. Moreover, the current display window can be returned to the previous display window by pressing the return switch 240.

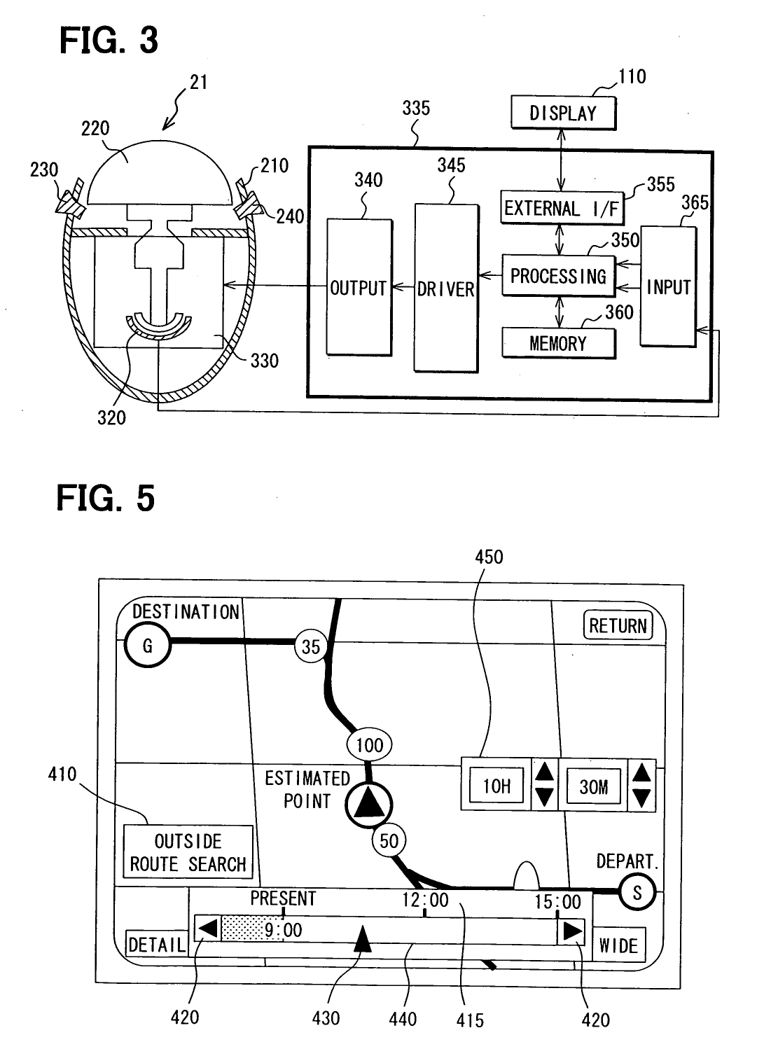

As illustrated in FIG. 3, the trackball holding unit 210 contains a trackball position detection unit 320 for detecting movement directions and movement amounts resulting from the rotation of the trackball unit 220, and an actuator unit 330 for controlling operation feelings of the trackball unit 220. The actuator unit 330 includes a double spindle motor and gives reaction force to the direction reverse to the rotational movement direction according to the rotational amount of the trackball unit 220. Next, a configuration of a controller 335 for controlling the haptic device 21 is explained using FIG. 3. The controller 335 takes in position information detected in the trackball position detection unit 320 through the input unit 365. Based on the taken-in position information, a display control signal is outputted to the display device 110 through the external interface unit 355 for moving the position of the pointer. Thereby, the data processing unit 350 can move the position of the pointer displayed on the display screen according to an operation of the trackball unit 220 by the user. Furthermore, the data processing unit 350 calculates the reaction force which should be given to the trackball unit 220 according to the operation of the trackball unit 220 by the user, and it outputs a driving signal to the actuator unit 330 through the driver circuit 345 and the output unit 340 so that the calculated reaction force may be generated.

In addition, the display position of the pointer before the haptic device 21 is operated is stored in a memory unit 360, and the data processing unit 350 generates the display control signal mentioned above based on the display position.

As mentioned above, although the haptic device 21 is explained as the operation device 108 of the present embodiment, another device may be used as the operation device 108. For example, a joy stick may be used as an operation device having the same function as the haptic device 21. A touch panel sensor may be formed on the display screen of the display device 110 to perform various operations by touching directly on the display screen.

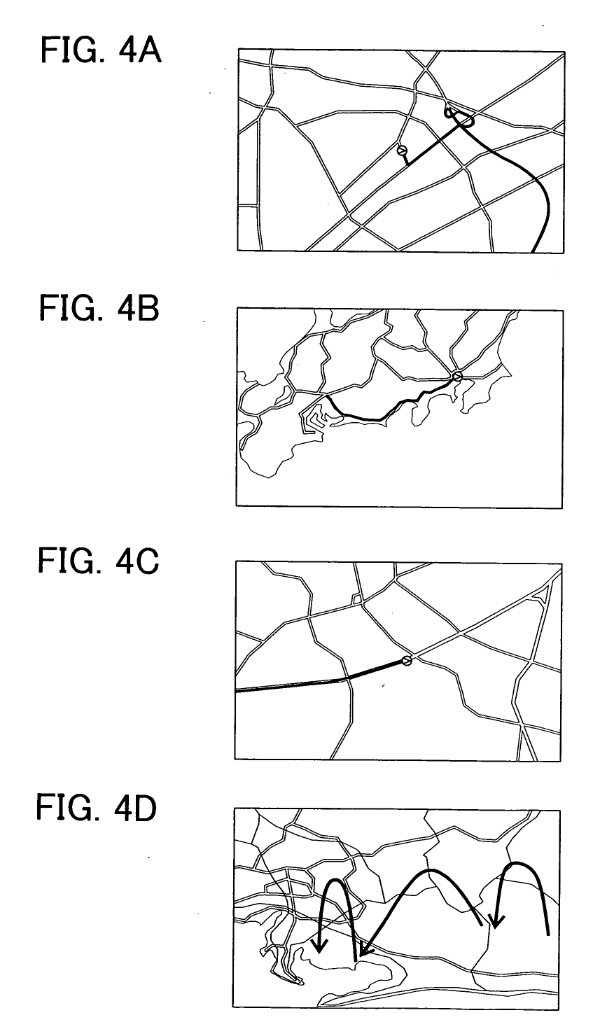

Next, the time scroll process characterizing the present embodiment is explained. FIG. 4A to 4C illustrate display examples of the road maps by the time scroll process, and the concept of the time scroll process is explained based on these drawings.

The time scroll process takes place on the assumption that a guide route is designated from a departure point to a destination. It is convenient for a user to recognize a reachable point on the guide route in a certain time period (e.g., several hours) after the vehicle leaves the departure point. For example, if the user can check a peripheral area of a point the vehicle will be traveling at the time when the user should take a rest or have a meal, the user may search for a facility suitable for the rest or meal in the checked peripheral area.

For example, FIG. 4A shows a road map in proximity of a departure point, while FIG. 4C shows a road map in proximity of a reachable point the vehicle is assumed to travel after a transit time period from leaving the departure point. If a displayed road map changes directly from the road map in FIG. 4A to the road map in FIG. 4C, it is difficult for the user to understand the positional relationship of the displayed road map in FIG. 4C against the guide route. To that end, in the present embodiment, before displaying the road map in proximity of the vehicle's position after the transit time period (i.e., in proximity of the estimated reachable point), another road map illustrated in FIG. 4B is once displayed which has a covering range including both the departure point and the estimated point reachable after the transit time period. Thus, the user can recognize the positional relationship between the estimated reachable point (or estimated arrival point) and the departure point. Further, the user can roughly recognize a route from the departure point to the reachable point, a position at which the reachable point is located in the guide route, etc.

In addition, reduction scales of the road maps illustrated in FIG. 4A and FIG. 4C are the same reduction scale, which is specified by the user. The reduction scale of the road map illustrated in FIG. 4B is varied according to the distance between the departure point and the estimated reachable point such that the covering range of the road map includes both the departure point and the estimated reachable point.

Moreover, when changing the display from the road map of a first reduction scale of FIG. 4B to the road map of a second reduction scale of FIG. 4C, it is desirable to change the display while the reduction scale seems to be continuously change from the first reduction scale to the second reduction scale, instead of changing directly from the first reduction scale to the second reduction scale.

Thus, the covering range including both the departure point and the estimated reachable point is smoothly switched to the covering range including only the estimated reachable point, which is centered in the covering range. The reduction scale of the road map displayed becomes larger continuously in connection with continuously changing the covering range to the narrower one. Therefore, the display device 110 can continuously change the display from the whole of the guide route including both the departure point and the estimated reachable point to the peripheral area of the estimated reachable point. The display can be thus intelligibly provided to the user.

In addition, FIG. 4D illustrates a case where peripheral maps about multiple points on the guide route can be displayed in order by the time scroll process in the present embodiment. For instance, at first, the first estimated reachable point is displayed by inputting a transit time period from the departure point. The transit time period corresponding to the first estimated reachable point is then increased by an additional transit time period. The peripheral map of the second estimated reachable point, which is reachable by the additional transit time period from the first reachable point, can be thereby displayed. Similarly, the peripheral map of the third estimated reachable point can be also displayed.

In such a case, the road map having a covering range including both the first estimated reachable point and the second estimated reachable point can be displayed before displaying the peripheral map of the second estimated reachable point. It is more desirable to display the road map having the covering range including both the departure point and the second estimated reachable point. It is because the mutual positional relationship of the departure point, the first estimated reachable point, and the second estimated reachable point can be checked collectively.

FIG. 5 is an example of an operation window in the time scroll process. Such an operation window is called and displayed by performing a predetermined switch operation of demanding the time scroll process.

In the operation window illustrated in FIG. 5, a departure point is defined to correspond to the present clock time. A transit time period from the departure point is inputted by adding a desired time period to the present clock time to thereby obtain a future clock time or by subtracting a desired time period from the present clock time to thereby obtain a past clock time. Thus, for instance, when starting a travel according to the guide route, it becomes easy to recognize the estimated reachable point based on the relation with the future clock time. That is, the user can recognize directly the future clock time when the vehicle arrives at the estimated reachable point, which is being displayed.

A time scroll bar 415 and a time setting bar 450 are prepared in the operation window of FIG. 5 for inputting a clock time. In the time scroll bar 415, a desired clock time can be specified by scrolling a time pointer 430 to accord with the clock time in a designation bar 440. The time pointer 430 can be scrolled directly along the time scroll bar 415 by the haptic device 21, scrolled by moving the touch position on the time scroll bar 415 in the display screen, or scrolled by operating pointer operation keys 420 prepared in the both ends of the time scroll bar 415. The time setting bar 450 is used to designate a clock time numerically. Thus, any combination of the haptic device 21 as the operation device 108, the time scroll bar 415, and a time setting bar 450 can function as an input means or device configured to input a transit time period based on an operation of a user.

When inputting a clock time using the time scroll bar 415, the time pointer 430 is scrolled to thereby increase or decrease the inputted clock time. In such a case, it is desirable to display the road map while changing the reduction scale continuously so that the covering range includes the departure point and the estimated reachable point which changes continuously according to the clock time being inputted. Thus, the user can recognize a reachable point according to an increase or decrease of the inputted clock time. When the intended clock time is eventually determined, the corresponding reachable point can be more intelligibly recognized in the positional relationship with the guide route or the departure point.

When the scroll rate of the time pointer 430 on the time scroll bar 415 is too quick, the map display accompanied by change of the reduction scale is completed in only a slight time period. In order to give room to afford to check the map change, an upper limit speed is preset in the change of the reduction scale of the road map. When the change speed of the road map scale by the operation of the time pointer 430 exceeds the upper limit speed, it is desirable to change the scale of the road map continuously according to the upper limit speed. Thus, the change speed of the road map scale can be certainly restricted to be below the upper limit speed. This can prevent that the scale of the road map changes quickly too much, and the visibility of the road map by the user can be improved.

In contrast, the input of the clock time using the time setting bar 450 is not continuously changed. When the final clock time is inputted, a road map of the small reduction scale having a covering range including both the departure point and the estimated reachable point is displayed for a predetermined time period. The reduction scale of the road map then becomes larger continuously toward the covering range centering on the estimated reachable point.

When the clock time inputted by the time scroll bar 415 or the time setting bar 450 is over the arrival time to the destination, multiple points reachable from the destination in the time difference between the inputted clock time and the arrival time to the destination are calculated. Then the road map having a covering range including the departure point and all the multiple reachable points is displayed as a road map with the first reduction scale. In such a case, the suitable reduction scale is selected such that all of the multiple reachable points are included in the covering range. The road map with the selected reduction scale is thus displayed. Thus, even if the user inputs a clock time later than the arrival time to the destination by a certain excess time period (i.e., time difference), a point (multiple points) which is reachable from the destination in the time difference can be displayed.

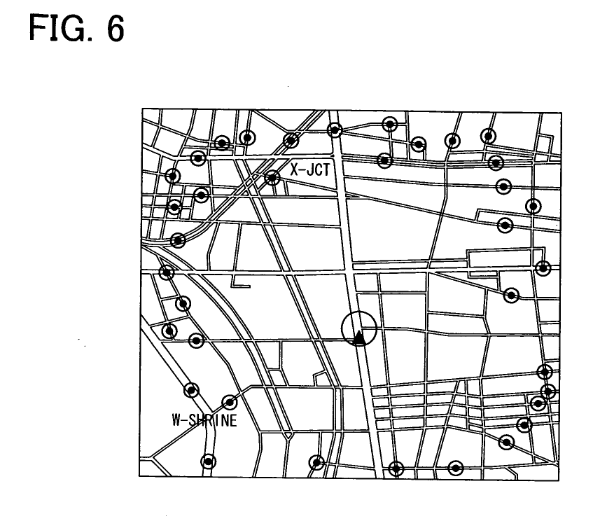

FIG. 6 illustrates an example of the road map which displays multiple reachable points which can be reached from the destination. In FIG. 6, the multiple points reachable from the destination are displayed with marks of double circles. To illustrate the multiple reachable points, a reachable region can be defined from the multiple reachable points and the defined region may be simultaneously displayed. Alternatively, only the reachable region may be displayed with the individual reachable points omitted from the display. Moreover, the displayed reachable region or points may be accompanied by marks illustrating facilities present inside the reachable region. Thereby, it becomes easy for the user to look for a facility to stop by in the reachable region.

Moreover, the time scroll bar 415 and the time setting bar 450 can also input a former clock time (a past clock time) earlier than the present clock time. When the past clock time is inputted, multiple points reachable from the departure point in the time difference from the present clock time are calculated and a road map having a covering range including the multiple points is then displayed. In the present embodiment, the departure point is defined to correspond to the present clock time. Thus, when the past time is inputted, it is supposed that the time difference is the time period required to reach the departure point from a certain point. When the past clock time is inputted, a road map appears to illustrate multiple points reachable from the departure point in the time difference. Thus, the user can be provided with an aggregate of points from which the user can reach the departure point in the time difference. For instance, the user may need to finish errands before starting the departure point. In such a case, the user can be provided with useful information for planning a travel schedule.

The display method of multiple points based on inputting the past clock time is the same as the display method of multiple points based on inputting the clock time later than the arrival time to the destination mentioned above. Moreover, the guide route is used as a reference when a point reachable from the departure point is displayed. The guide route may be also designated in the past and stored by the external memory 9.

Moreover, as illustrated in the operation window of FIG. 5, an outside route search key 410 is formed in the present embodiment. At first, the present point mark of the vehicle is scrolled to move by the time scroll process. The outside route search key 410 is then used to demand retrieval of a point outside of the guide route. The point is able to be reached from the moved present position mark within a predetermined time period. For instance, when a predetermined clock time is inputted, the time scroll process is performed and completed. Then, as the outside route search key 410 is operated and the inputted clock time is increased by an additional time period, multiple points which can be reached by the additional time period are calculated and displayed. The display method is the same as that of the example mentioned above. Therefore, the user can check easily a point or region reachable from a certain point on the guide route in the predetermined time period. For instance, a driver may afford a time to visit a point before arriving at a destination. In such a case, under the above configuration, the driver can search for the point to be visited for the limited time period. The user's convenience can be thereby improved.

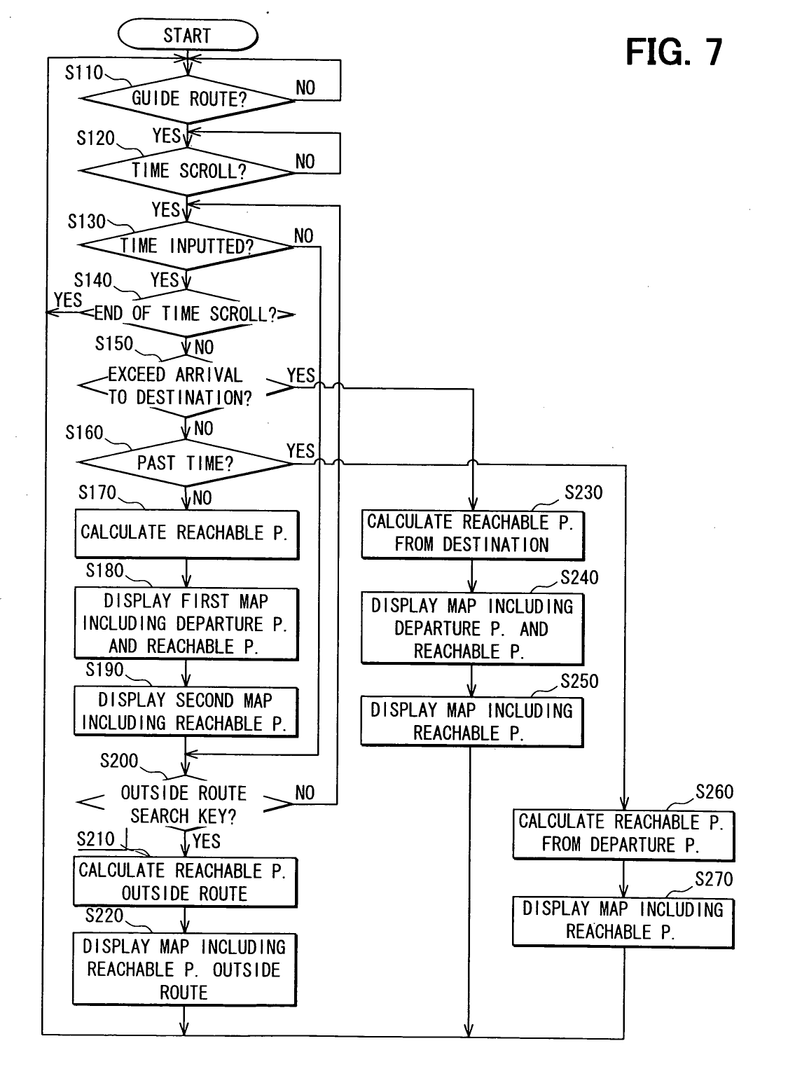

Next, a control process of the time scroll process, which is executed by the control circuit 112, is explained based on the flowchart of FIG. 7. At Step S110, it is determined whether a guide route is designated. The determination is affirmed when a departure point and a destination are designated and a guide route is retrieved or when a stored guide route is read out. When a departure point is not specified, it is supposed that the present point is regarded as a departure point.

When it is determined that a guide route is not designated, processing stands by until the guide route is designated. When it is determined that a guide route is designated, processing proceeds to Step S120. At Step S120, it is determined whether a switch operation of demanding a time scroll process is performed. When it is determined that a switch operation is not performed, processing stands by until a switch operation is performed. When it is determined that a switch operation is performed, processing proceeds to Step S130. In addition, based on the performed switch operation of demanding a time scroll process, the operation window illustrated in FIG. 5 is displayed on the display screen in the display device 110.

At Step S130, it is determined whether a clock time is inputted or not. When it is determined that a clock time is inputted, processing proceeds to Step S140. When it is determined that a clock time is not inputted, processing proceeds to Step S200.

At Step S140, it is determined whether a predetermined switch operation of demanding ending of the time scroll process is performed. When it is determined that the switch operation is performed, processing returns to Step S110. In contrast, when it is determined that the switch operation is not performed, processing proceeds to Step S150.

At Step S150, it is determined whether the inputted clock time exceeds the estimated time of arrival to the destination. In addition, the estimated time of arrival to the destination is calculated based on the distance to the destination and estimated travel speed defined according to the kind of each road in the guide route. When it is determined that the inputted clock time exceeds the estimated time of arrival to the destination, processing proceeds to Step S230. When it is determined that the inputted clock time does not exceed the estimated time of arrival to the destination, processing proceeds to Step S160.

At Step S160, it is determined whether the inputted clock time is a past clock time earlier than the present clock time. When it is determined that the inputted clock time is a past time, processing proceeds to Step S260. When it is determined that the inputted clock time is not a past time, processing proceeds to Step S170. At Step S170, a reachable point on the guide route corresponding to the inputted clock time is calculated. Thus, Step S170 executed by the control circuit 112 can function as a reachable point calculation means or unit configured to calculate a reachable point on the guide route, the reachable point which the vehicle is estimated to reach when a transit time period elapses after the vehicle starts from a departure point. At subsequent Step S180, a road map of a first reduction scale having a covering range including the departure point and the calculated reachable point is displayed in the display device 110.

In addition, the inputted clock time may increase or decrease continuously by the time scroll bar 415. In such a case, a reachable point is calculated to dynamically correspond to the inputted clock time continuously increasing or decreasing at Step S170, and the reduction scale of the displayed road map is continuously changed to have a covering range including the departure point and the dynamically calculated reachable point at Step S180. However, when the change in the inputted clock time is too quick and the change speed of the scale of the road map exceeds a predetermined upper limit speed, the change speed of the scale of the road map is restricted to the upper limit speed. At Step S180, the display of the road map of the first reduction scale is continued from when the inputted clock time becomes fixed to when a predetermined time period passes. Then, processing proceeds to Step S190.

The road map of the second reduction scale centering on the calculated reachable point (i.e., the peripheral map of the calculated reachable point) is displayed at Step S190. The change in the reduction scale of the road map is performed not quickly but gradually from the first reduction scale to the second reduction scale, as mentioned above. Thus, Steps S180, S190 executed by the control circuit 112 can function as a display control means or unit configured to cause the display device to display a road map with a first reduction scale having a covering range including a departure point and a reachable point and then to display a road map with a second reduction scale having a covering range including the reachable point, the covering range of the second reduction scale being narrower than the covering range of the first reduction scale.

At Step S200, it is determined whether the outside route search key 410 is operated. When it is determined that the search key 410 is not operated, processing returns to Step S130 in order to prepare for an input of a clock time corresponding to the second reachable point. When it is determined that the search key 410 is operated, processing proceeds to Step S210.

At Step S210, a point is calculated which is outside of the guide route and which is reachable from the reachable point calculated at Step S170 in a time period corresponding to an increased part of the clock time inputted by the clock time scroll bar 415 or the time setting bar 450. Here, multiple points outside of the guide route may be usually calculated. At Step S220, a road map is displayed to include the calculated reachable point(s). Thus, the outside route search key 410 can function as a demand means or device configured to demand a retrieval of a reachable range from a certain point based on an operation of a user, the certain point being on the guide route.

As explained above, when it is determined at Step S150 that the inputted clock time exceeds the estimated time of arrival to the destination, processing proceeds to Step S230. At Step S230, a reachable point is calculated which is reachable from the destination in a time period corresponding to a time difference between the inputted clock time and the estimated time of arrival to the destination. At Step S240, the road map having a covering range which includes the departure point and all the calculated points reachable from the destination is displayed for a predetermined time period. Next, at Step S250, a road map is displayed which has a covering range including the calculated point(s) reachable from the destination. In such a case, the reduction scale of the displayed road map is increased gradually from the reduction scale of the road map displayed at Step S240.

As explained above, when it is determined at Step S160 that the past clock time is inputted, processing proceeds to Step S260. At Step S260, a reachable point is calculated which is reachable from the departure point in a time period corresponding to the time difference between the inputted clock time and the present clock time. At Step S270, a road map is displayed which has a covering range including all the calculated points reachable from the departure point.

Although the preferred embodiment of the present invention is described above, the present invention can be modified and executed within a scope not deviating from the subject matter of the present invention without being restricted to the embodiment mentioned above.

For example, in the embodiment mentioned above, before displaying the peripheral map of the calculated or estimated reachable point corresponding to the inputted clock time, the road map of the first reduction scale is displayed which has a covering range including the departure point and the estimated reachable point. Alternatively, another road map may be displayed which has a covering range including the whole of the guide route coupling the departure point and the destination with each other, as a road map of the first reduction scale. Thus, while the whole of the guide route is displayed, the estimated reachable point corresponding to the inputted transit time period is displayed. The user can therefore recognize more clearly the positional relationship of the estimated reachable point against the whole of the guide route.

Each or any combination of processes, steps, or means explained in the above can be achieved as a software unit (e.g., subroutine) and/or a hardware unit (e.g., circuit or integrated circuit), including or not including a function of a related device; furthermore, the hardware unit can be constructed inside of a microcomputer.

Furthermore, the software unit or any combinations of multiple software units can be included in a software program, which can be contained in a computer-readable storage media or can be downloaded and installed in a computer via a communications network.

(Aspects)

Aspects of the disclosure described herein are set out in the following clauses.

As an aspect of the disclosure, a map display apparatus for a vehicle is provided as follows. A road map data storage device is configured to store road map data. A display device is configured to display a road map using the road map data. A guide route designation unit is configured to designate a guide route from a departure point to a destination based on the road map data. An input device is configured to input a transit time period based on an operation of a user. A reachable point calculation unit is configured to calculate a reachable point on the guide route, the reachable point which the vehicle is estimated to reach when the transit time period elapses after the vehicle starts from the departure point. A display control unit is configured to cause the display device to display a road map with a first reduction scale having a covering range including the departure point and the reachable point and then to display a road map with a second reduction scale having a covering range including the reachable point, the covering range of the second reduction scale being narrower than the covering range of the first reduction scale.

Thus, the user can recognize the positional relationship between the reachable point and the departure point. Further, the user can roughly estimate a position of the reachable point (or arrival point) based on a route from the departure point.

As an additional aspect of the map display apparatus, the following may be provided. If the inputted transit time period exceeds, by an excess time period, a travel time period required to reach the destination, the reachable point calculation unit may calculate multiple points reachable during the excess time period, and the display control unit may cause the display device to display as a road map with the first reduction scale a road map covering the departure point and the multiple reachable points and as a road map with the second reduction scale a road map indicating a reachable range defined by the multiple reachable points. Thus, even if the user inputs a transit time period longer than the time period required to reach the destination on the guide route by a certain excess time period, a road map is displayed to indicate a point (or multiple points) which is reachable in the certain excess time period from the destination.

As an additional aspect of the map display apparatus, the following may be provided. A demand device may be further configured to demand a retrieval of a reachable range from a certain point based on an operation of a user, the certain point being on the guide route. Here, if the retrieval is demanded, the reachable point calculation unit may calculate multiple points reachable from the certain point for a transit time period inputted by the input device, and the display control unit may cause the display device to display a road map indicating a reachable range defined by the multiple points reachable from the certain point. By providing such a demand device, the user can easily check a range, which is reachable in the intended transit time period from a point on the guide route. For instance, a driver may afford a time to visit a point before arriving at a destination. In such a case, under the above configuration, the driver can search for the point to be visited during the limited time period and the user's convenience can be therefore improved.

As an additional aspect of the map display apparatus, the following may be provided. The input device may be further configured to input a minus transit time period. Here, if a minus transit time period is inputted, the reachable point calculation unit may calculate multiple points reachable from the departure point for a plus transit time period, which is obtained by multiplying the minus transit time period by minus one, and the display control unit may cause the display device to display a road map indicating a reachable range defined by the multiple points reachable from the departure point. The transit time period is defined on the basis of the departure point. The minus transit time period is assumed to be a time period in which the driver can reach the departure point from a certain point. When the minus transit time period is inputted, a road map appears to illustrate a range, which is defined by multiple points reachable from the departure point in the excess time period. Thus, the user can be provided with an aggregate of points from which the user can reach the departure point for the excess time period. For instance, the user may need to finish errands before leaving the departure point. In such a case, the user can be provided with useful information for planning a travel schedule.

Under the above additional aspects of the map display apparatus, the following may be yet additionally provided. When the display control unit causes the display device to display the road map indicating the reachable range, a reduction scale of the road map may be changed according to the reachable region. The visibility of the reachable range can be therefore improved.

Under the above additional aspects of the map display apparatus, the following may be yet additionally provided. When the display control unit causes the display device to display the road map indicating the reachable range, a mark of a facility within the reachable range may be additionally displayed in the display device. Thereby, it becomes easy for the user to look for a facility to stop by within the reachable region.

As an additional aspect of the map display apparatus, the following may be provided. The input device may be configured to input an intended transit time period by one-directionally increasing or decreasing. Here, while the reachable point calculation unit continuously calculates a reachable point corresponding to the transit time period being one-directionally increased or decreased, the display control unit may change a reduction scale of a road map to include the calculated reachable point. Thus, the user can recognize a reachable point according to an increase or decrease of the inputted transit time period. When the intended transit time period is eventually inputted, the reachable point according to the inputted transit time period can be more intelligibly recognized in the positional relationship with the guide route or the departure point.

Under the above additional aspect of the map display apparatus, the following may be further provided. If a change speed of the reduction scale exceeds a predetermined upper speed, the display control unit may continuously change the reduction scale of the road map according to the predetermined upper speed. Since the change speed can be restricted to be below the predetermined upper limit, the reduction scale of the road map can be prevented from changing quickly too much. The visibility of the road map can be thus improved.

As an additional aspect of the map display apparatus, the following may be provided. The display control unit may cause the display device to display as the road map with the first reduction scale a road map having a covering range including all the guide route coupling the departure point and the destination with each other. Thus, the reachable point can be recognized more clearly in the position thereof with respect to the guide route.

As an additional aspect of the map display apparatus, the following may be provided. When the display control unit switches from the road map with the first reduction scale to the road map with the second reduction scale, the display control unit may cause the display device to display a road map continuously changing a reduction scale from the first reduction scale to the second reduction scale. Thus, the covering range converges smoothly to include only the estimated reachable point. The reduction scale of the road map displayed becomes large continuously as the covering range continuously contracts. Therefore, the displayed road map can indicate a covering range from the whole of the guide route to the proximity of the estimated reachable point continuously, so the user can be provided with the display very intelligible.

As an additional aspect of the map display apparatus, the following may be provided. The input device may be configured to input as the transit time period a clock time following or preceding a present clock time by adding a predetermined time period to the present clock time or subtracting a predetermined time period from the present clock time. Thus, when starting a travel according to the guide route, it becomes easy to recognize the estimated reachable point based on the relation with the future clock time. That is, the user can recognize directly the future clock time when the vehicle arrives at the estimated reachable point, which is being displayed.

As an additional aspect of the map display apparatus, the following may be provided. The guide route designation unit may be configured to include a storage device to store a guide route previously designated. Thus, the user can use a guide route designated in the past.

It will be obvious to those skilled in the art that various changes may be made in the above-described embodiments of the present invention. However, the scope of the present invention should be determined by the following claims.

What is claimed is:

1. A map display apparatus for a vehicle, the apparatus comprising:
a road map data storage device configured to store road map data;
a display device configured to display a road map using the road map data;
a guide route designation unit configured to designate a guide route from a departure point to a destination based on the road map data;
an input device configured to input a transit time period based on an operation of a user;
a reachable point calculation unit configured to calculate a reachable point on the guide route, the reachable point which the vehicle is estimated to reach when the transit time period elapses after the vehicle starts from the departure point; and
a display control unit configured to cause the display device to display a road map with a first reduction scale having a covering range including the departure point and the reachable point and then to display a road map with a second reduction scale having a covering range including the reachable point, the covering range of the second reduction scale being narrower than the covering range of the first reduction scale.

2. The map display apparatus according to claim 1, wherein
if the inputted transit time period exceeds, by an excess time period, a travel time period required to reach the destination,
the reachable point calculation unit calculates multiple points reachable during the excess time period and
the display control unit causes the display device to display as a road map with the first reduction scale a road map covering the departure point and the multiple reachable points and as a road map with the second reduction scale a road map indicating a reachable range defined by the multiple reachable points.

3. The map display apparatus according to claim 1, further comprising:
a demand device configured to demand a retrieval of a reachable range from a certain point based on an operation of a user, the certain point being on the guide route, wherein
if the retrieval is demanded,
the reachable point calculation unit calculates multiple points reachable from the certain point for a transit time period inputted by the input device, and
the display control unit causes the display device to display a road map indicating a reachable range defined by the multiple points reachable from the certain point.

4. The map display apparatus according to claim 1, wherein:
the input device is further configured to input a minus transit time period; and
if a minus transit time period is inputted,
the reachable point calculation unit calculates multiple points reachable from the departure point for a plus transit time period, which is obtained by multiplying the minus transit time period by minus one, and
the display control unit causes the display device to display a road map indicating a reachable range defined by the multiple points reachable from the departure point.

5. The map display apparatus according to claim 2, wherein
when the display control unit causes the display device to display the road map indicating the reachable range,
a reduction scale of the road map is changed according to the reachable region.

6. The map display apparatus according to claim 2, wherein
when the display control unit causes the display device to display the road map indicating the reachable range,
a mark of a facility within the reachable range is additionally displayed in the display device.

7. The map display apparatus according to claim 1, wherein:
the input device is configured to input an intended transit time period by one-directionally increasing or decreasing; and
while the reachable point calculation unit continuously calculates a reachable point corresponding to the transit time period being one-directionally increased or decreased,
the display control unit changes a reduction scale of a road map to include the calculated reachable point.

8. The map display apparatus according to claim 7, wherein
if a change speed of the reduction scale exceeds a predetermined upper speed,
the display control unit continuously changes the reduction scale of the road map according to the predetermined upper speed.

9. The map display apparatus according to claim 1, wherein
the display control unit causes the display device to display as the road map with the first reduction scale a road map having a covering range including all the guide route coupling the departure point and the destination with each other.

10. The map display apparatus according to claim 1, wherein
when the display control unit switches from the road map with the first reduction scale to the road map with the second reduction scale,
the display control unit causes the display device to display a road map continuously changing a reduction scale from the first reduction scale to the second reduction scale.

11. The map display apparatus according to claim 1, wherein
the input device is configured to input as the transit time period a clock time following or preceding a present clock time by adding a predetermined time period to the present clock time or subtracting a predetermined time period from the present clock time.

12. The map display apparatus according to claim 1, wherein
the guide route designation unit configured to include a storage device to store a guide route previously designated.
